(19) United States
(12) Patent Application Publication
(10) Pub. No.: US 2015/0115583 A1
(43) Pub. Date: Apr. 30, 2015

(54) AIRBAG DEVICE

(71) Applicant: ASHIMORI INDUSTRY CO., LTD., Osaka-shi, Osaka (JP)

(72) Inventors: Hidetaka Azuma, Settu-shi (JP); Katsunori Imai, Settu-shi (JP); Miwa Matsuoka, Settu-shi (JP)

(73) Assignee: ASHIMORI INDUSTRY CO., LTD., Osaka-shi, Osaka (JP)

(21) Appl. No.: 14/396,413

(22) PCT Filed: Apr. 23, 2013
(86) PCT No.: PCT/JP2013/061945

§ 371 Date: Oct. 23, 2014

(30) Foreign Application Priority Data
May 9, 2012 (JP) 2012-107449

(51) Int. Cl. B60R 21/26; B60R 21/276

(52) U.S. Cl. CPC B60R 21/26; B60R 21/276
USPC 280/740; 280/741

(57) ABSTRACT

A chamber required to be inflated and deployed at an early stage in an airbag is inflated and deployed in advance so as to protect an occupant at an early stage. An airbag device (1A) is provided with an airbag (10A) which protects an occupant (90) in a vehicle by inflation and deployment by gas, and an inflator (3) which supplies the gas to the airbag (10A). The airbag (10A) has a first chamber (20), a gas distribution port (14) provided in the first chamber (20), and a second chamber (30). The first chamber (20) stores an inflator (3) and is inflated by the gas supplied from the inflator (3). The second chamber (30) surrounds a part of the first chamber (20) including the distribution port (14) and is inflated by the gas supplied from the distribution port (14).

### TECHNICAL FIELD

The present invention relates to an airbag device having a plurality of chambers within an airbag.

### BACKGROUND ART

In order to protect an occupant in a vehicle in the vehicle emergency and at the time of the vehicle collision, various airbags are used. In the airbag device, the occupant is received by the airbag which inflates and deploys within the vehicle, and impact shock applied to the occupant is absorbed. At this time, in order to reliably protect the occupant, it is necessary to deploy the airbag to a predetermined position within the vehicle. In contrast, there has been conventionally known an airbag (a side airbag device) which suppresses motion of a head protecting inflation portion and a waist protecting inflation portion by amain inflation portion having a function of a support column, at the time of inflation and deployment (refer to patent literature 1).

However, in the conventional airbag, the main inflation portion inflates and deploys in advance by suppressing inflow of gas into the head protecting inflation portion and the waist protecting inflation portion, and the head protecting inflation portion and the waist protecting inflation portion inflate and deploy thereafter. As a result, it is not possible to inflate and deploy the head protecting inflation portion required to be inflated and deployed at an early stage, in a lateral portion of the head at an early stage, and there is a risk that the head comes into contact with the head protecting inflation portion before the inflation and deployment is completed. Therefore, there is room for improvement from the viewpoint of protecting the occupant at an early stage.

Furthermore, in the waist protecting inflation portion, a timing when the waist of the occupant comes into contact therewith tends to fluctuate, and the waist may come into contact with the waist protecting inflation portion during inflation and deployment. In that case, the impact shock cannot be sufficiently absorbed by the waist protecting inflation portion, and thus there is a risk that an amount of absorbing the impact shock becomes small. As described above, in the conventional airbag, it is hard to cope with the fluctuation of timing when the occupant comes into contact, in protecting the occupant by the portion which inflates and deploys belatedly.

### CITATION LIST

### Patent Literature

PTL 1: Japanese Patent Laid-Open No. 2011-5908

### SUMMARY OF INVENTION

### Technical Problem

The present invention has been made by taking the above-mentioned conventional problem into consideration, and an object of the present invention is to make an chamber required to be inflated and deployed at an early stage in an airbag, inflate and deploy in advance so as to protect an occupant at an early stage, and to absorb impact shock even when the occupant comes into contact with the other chamber during inflation and deployment, thereby protecting the occupant.

### Solution to Problem

The present invention is an airbag device including an airbag which protects an occupant in a vehicle by inflation and deployment by gas and an inflator which supplies the gas to the airbag, wherein the airbag has a first chamber which stores the inflator, the first chamber being inflatable by the gas supplied from the inflator, a gas distribution port provided in the first chamber, and a second chamber which surrounds a part of the first chamber including the distribution port, the second chamber being inflatable by the gas supplied from the distribution port.

### Advantageous Effects of Invention

According to the present invention, it is possible to inflate and deploy in advance the chamber required to be inflated and deployed at an early stage in the airbag so as to protect the occupant at an early stage. Furthermore, even in the case where the occupant comes into contact with the other chamber during the inflation and deployment, it is possible to protect the occupant by absorbing the impact shock.

### BRIEF DESCRIPTION OF DRAWINGS

FIG. 1 is a side view of a seat which mounts an airbag device according to a first embodiment;

FIG. 2 is a side view showing an inflated and deployed airbag according to the first embodiment;

FIGS. 3A to 3C are views showing the airbag according to the first embodiment;

FIGS. 4A to 4D are views showing a deployment process of the airbag according to the first embodiment;

FIGS. 5A to 5C are views showing the airbag according to the first embodiment, which protects a body of an occupant;

FIGS. 6A to 6C are views showing an airbag device according to a second embodiment;

FIG. 7 is a side view showing an inflated and deployed airbag according to the second embodiment;

FIGS. 8A to 8C are views showing an airbag device according to a third embodiment;

FIGS. 9A and 9B are views showing an airbag device according to a fourth embodiment;

FIGS. 10A and 10B are views showing an airbag device according to a fifth embodiment;

FIGS. 11A to 11C are views showing an airbag device according to a sixth embodiment;

FIG. 12 is a view showing an airbag device according to a seventh embodiment; and

FIG. 13 is a view showing an airbag device according to an eighth embodiment.

### DESCRIPTION OF EMBODIMENTS

A description will be given of an embodiment of an airbag device according to the present invention with reference to the accompanying drawings.

The airbag device according to the present embodiment is an occupant protection device which is mounted within a vehicle and which protects an occupant in the vehicle, and is attached to an attaching portion of the vehicle. In each of the following embodiments, a description will be given by exemplifying the case where the airbag device is a side airbag device which protects the occupant between the occupant seated on a seat and a side wall of the vehicle. The occupant is received and protected by the airbag which inflates and deploys along the side wall within the vehicle.

### First Embodiment

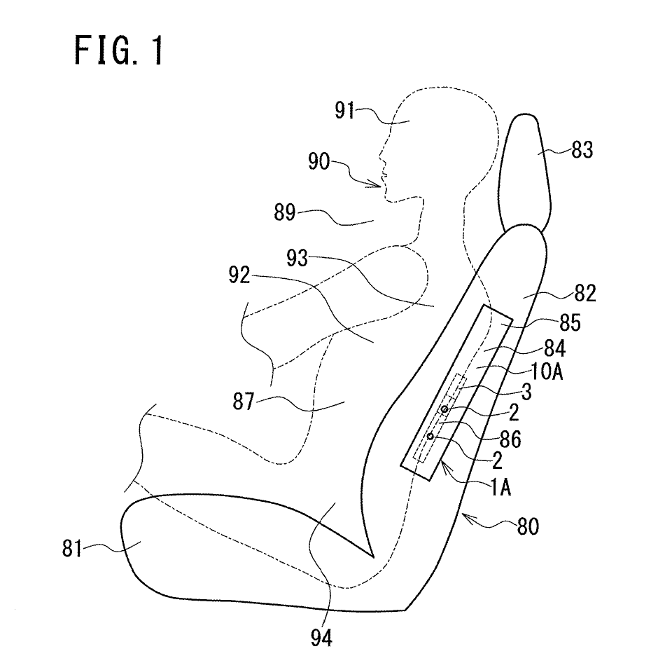

FIG. 1 is a side view of a seat 80 which mounts an airbag device 1A according to a first embodiment, and shows the seat 80 and an occupant 90 viewed from an inner side of the vehicle. Furthermore, the airbag device 1A is shown by seeing through the seat 80.

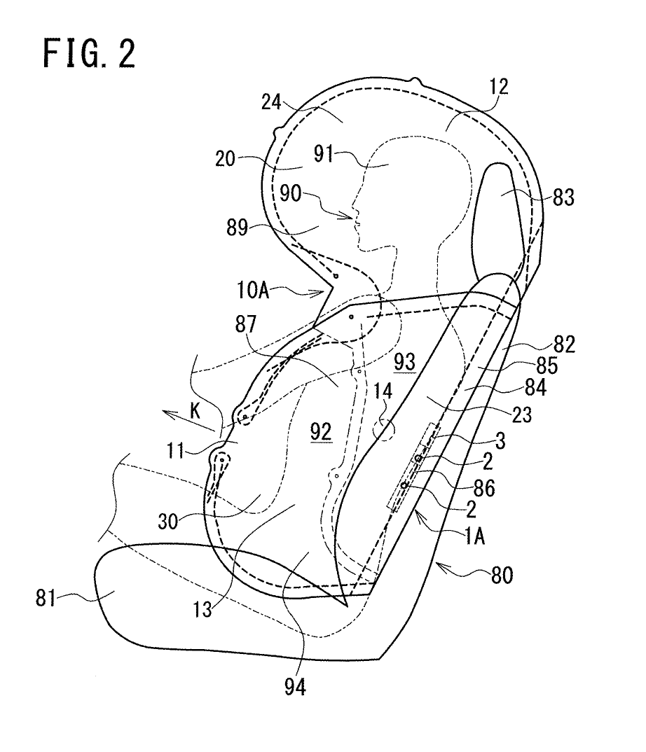

FIG. 2 is a side view showing an inflated and deployed airbag 10A according to the first embodiment, and the airbag 10A is shown with the seat 80 and the occupant 90 in an overlapped manner.

In FIGS. 1 and 2, a left-hand side corresponds to a front side in the vehicle, and a right-hand side corresponds to a rear side in the vehicle. Here, the front side, the rear side, an upper side and a lower side in the vehicle are respectively referred to as a front side, a rear side, an upper side and a lower side. In addition, a longitudinal direction and a vertical direction in the vehicle are respectively referred to as a longitudinal direction and a vertical direction, and a width direction of the vehicle is referred to as a width direction.

A side wall 89 of the vehicle is constituted of a member (a door trim or a window) provided on the side within the vehicle, and is positioned at a back side of the seat 80 and the occupant 90 (a back side of a paper surface) in FIGS. 1 and 2.

The seat 80 corresponds to various seats (a driver seat, a front passenger seat and a rear seat) for the vehicle, and has a seat cushion 81 on which the occupant 90 seats, a seat back 82 positioned on a back surface of the occupant 90, a head rest 83, and a storage member 84 of the airbag device 1A. The storage member 84 is positioned on an outer side (a side wall 89 side) in a width direction within the seat back 82, and is provided in a side portion 85 (an outer portion in the width direction) of the seat 80.

The airbag device 1A (refer to FIG. 1) before operation is attached to an attaching portion 86 of the vehicle in a state of being stored in the storage member 84, and is mounted on the side portion 85 of the seat 80. The attaching portion 86 is a portion which is provided in the vehicle and to which the airbag device 1A is attached (here, the side portion 85 of the seat 80). The airbag device 1A is attached to the attaching portion 86 (for example, a seat frame) of the seat 80 within the side portion 85, and is arranged on a rear side and an outer side in the width direction (a side wall 89 side) of the occupant 90.

The airbag device 1A (the side airbag device) is provided with the bag-shaped airbag (side airbag) 10A, two attaching members 2 which are constituted of bolts, and a tubular inflator 3 (shown by a dotted line) which supplies gas to the airbag 10A. The airbag 10A is stored within the side portion 85 (the storage member 84) of the seat 80 in a folded state so as to be able to inflate and deploy. The airbag 10A and the inflator 3 are attached to the attaching portion 86 by the attaching members 2 which are fixed to the inflator 3.

The inflator 3 is a cylinder-type gas generating device, and is housed within the side portion 85 of the seat 80 together with the airbag 10A in a state of being arranged within the airbag 10A. In the vehicle emergency and at the time of impact shock detection, the inflator 3 is activated in response to an operating instruction signal received from an instruction device (not shown) of the vehicle, and the gas is generated within the airbag 10A. The gas is supplied into the folded airbag 10A, and the airbag 10A inflates and deploys along the side wall 89 by the gas (refer to FIG. 2). Furthermore, the airbag 10A inflates and deploys in a lateral space 87 between the occupant 90 seated on the seat 80 and the side wall 89, and protects the occupant 90 of the vehicle in the lateral space 87.

At the time of inflation and deployment, first, the airbag 10A jumps out from the side portion 85 of the seat 80 to an outside of the seat 80 (to a vehicle cabin), and deploys toward the lateral space 87 while inflating. Next, the airbag 10A deploys in a vertical direction while deploying to the front side of the seat back 82, and a whole of the airbag 10A inflates and deploys between the occupant 90 and the side wall 89. In this state, the occupant 90 is received and protected by the airbag 10A. Furthermore, since the gas within the airbag 10A is discharged forward from a vent hole 11 of the airbag 10A (as shown by an arrow K in FIG. 2), the impact shock of the occupant 90 is absorbed.

In the airbag device 1A, the airbag 10A inflates and deploys in a lateral portion of ahead 91 and a body 92 (a portion from a chest 93 to a waist 94) of the occupant 90, and protects the head 91 and the body 92. Namely, the airbag 10A inflates and deploys in a lateral space 87 which includes a lateral portion of the head 91 and a lateral portion of the body 92, and the head 91 and the body 92 are received by the airbag 10A. A size and a shape of the airbag 10A are set as correspondence to a shape of the lateral space 87 and a side shape of the occupant 90, and the airbag 10A is formed into a shape which is longer in the vertical direction than in the longitudinal direction.

The head 91 and the body 92 of the occupant 90 are received respectively by protection portions 12 and 13 of the airbag 10A, and the impact shock in the head 91 and the body 92 is absorbed by the protection portions 12 and 13 of the airbag 10A. At this time, the head 91 comes into contact with the head protection portion 12 of the airbag 10A, and the body 92 comes into contact with the body protection portion 13 of the airbag 10A. The head protection portion 12 is an upper inflation portion formed in an upper portion of the airbag 10A, and deploys more greatly upward than the body protection portion 13 in such a manner that the head protection portion 12 can protect a whole of the head 91. The body protection portion 13 is a lower inflation portion formed in a lower portion (a portion except the head protection portion 12) of the airbag 10A, and deploys in the vertical direction along the body 92.

Furthermore, a part of the airbag 10A is formed into a double structure in which two inflatable chambers (a first chamber 20 and a second chamber 30) overlap partly, and the occupant 90 is protected by two inflated chambers 20 and 30. An upper portion of the first chamber 20 is the head protection portion 12 positioned in an upper portion of the airbag 10A, and inflates in a lateral portion of the head 91 to thereby protect the head 91, whereas a lower portion of the first chamber 20 and the second chamber 30 are the double structure portion and the body protection portion 13 which are positioned in the lower portion of the airbag 10A, and inflate in a lateral portion of the body 92 to thereby protect the body 92. Hereinafter, a description will be in detail given of the chambers 20 and 30 of the airbag 10A.

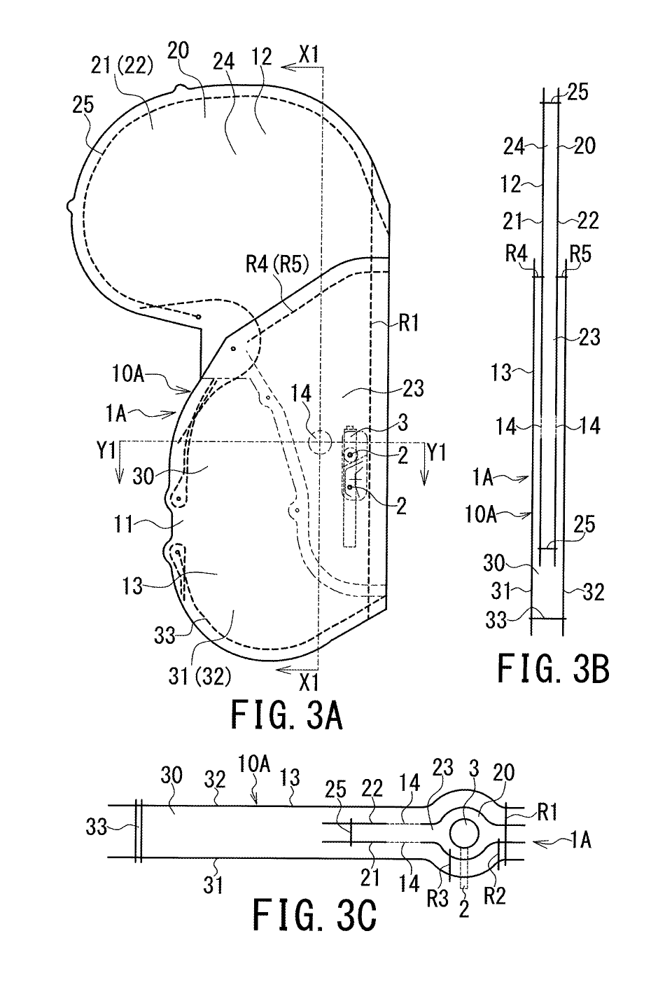

FIGS. 3A to 3C are views showing the airbag 10A according to the first embodiment, and schematically show the airbag 10A expanded on a flat surface. Furthermore, FIG. 3A is a side view of the airbag 10A corresponding to FIG. 2, FIG. 3B is a cross-sectional view of the airbag 10A which is cut along a line X1-X1 in FIG. 3A, and FIG. 3C is a cross-sectional view of the airbag 10A which is cut along a line Y1-Y1 in FIG. 3A.

The airbag 10A has the first chamber 20, two gas distribution ports 14 provided in the first chamber 20, the second chamber 30, and one vent hole 11 provided in the second chamber 30, as shown in the drawing.

The first chamber 20 has opposing base fabrics 21 and 22, an internal inflation portion 23 which inflates inside the second chamber 30, and an external inflation portion 24 which inflates outside the second chamber 30. The base fabrics 21 and 22 have the same shape, and are joined by a peripheral edge joint portion 25 in a state where the base fabrics 21 and 22 are superposed. The peripheral edge joint portion 25 is formed in a peripheral edge portion of the base fabrics 21 and 22 by joining the base fabrics 21 and 22 by sewing (or by sewing and adhesion). The peripheral edge portion of the opposing base fabrics 21 and 22 is closed by the peripheral edge joint portion 25, and the first chamber 20 (two inflation portions 23 and 24) is formed.

The internal inflation portion 23 is a tubular portion which is formed into a tubular shape in a lower portion of the first chamber 20, and is arranged inside the second chamber 30. Furthermore, the internal inflation portion 23 is arranged along the vertical direction in a rear portion of the second chamber 30, and is surrounded by the second chamber 30. The inflator 3 is attached to the attaching portion 86 of the vehicle by the attaching members 2 in a state where the inflator 3 is housed in the internal inflation portion 23 that is the tubular portion. At this time, the attaching members 2 pass through the first chamber 20 and the second chamber 30, and are fixed to the attaching portion 86 by a fixing member (nuts etc.) (not shown). Furthermore, the inflator 3 is attached to the attaching portion 86 together with the internal inflation portion 23 and the second chamber 30 overlapping the internal inflation portion 23, and the first chamber 20 and the second chamber 30 are retained at the attaching portion 86.

The external inflation portion 24 is an occupant protection portion which comes into contact with the occupant 90 to thereby protect the occupant 90, and is positioned outside the second chamber 30. Here, the external inflation portion 24 is the head protection portion 12 formed in an upper portion of the first chamber 20, and inflates above the second chamber 30 so as to protrude forward. The first chamber 20 constituted of these two inflation portions 23 and 24 houses the inflator 3 and inflates with the gas supplied from the inflator 3. At this time, the inflator 3 generates the gas within the internal inflation portion 23 of the first chamber 20, and supplies the gas toward the internal inflation portion 23 and the external inflation portion 24. The first chamber 20 first inflates and deploys by the gas, and the gas is filled in the first chamber 20. Furthermore, the first chamber 20 inflates and deploys toward the upper side, and the internal inflation portion 23 and the external inflation portion 24 gradually inflate.

The gas distribution port 14 of the first chamber 20 is constituted of circular through-holes which are formed in the base fabrics 21 and 22, and is provided in an internal inflation portion 23 of the first chamber 20. The distribution port 14 is positioned within the second chamber 30, and the gas within the first chamber 20 flows out of the distribution port 14 to the second chamber 30. The gas is distributed through the distribution port 14, and is supplied to the second chamber 30 from the first chamber 20. By the gas, the second chamber 30 inflates and deploys in the lateral space 87 after the inflation and deployment of the first chamber 20.

The second chamber 30 is an outer inflation portion which inflates in an outer side of the internal inflation portion 23, and has opposing base fabrics 31 and 32. The base fabrics 31 and 32 have the same shape, and are joined by a peripheral edge joint portion 33 in a state where the base fabrics 31 and 32 are overlapped with each other. The peripheral edge joint portion 33 is formed in a peripheral edge portion of the base fabrics 31 and 32 by joining the base fabrics 31 and 32 by sewing (or by sewing and adhesion). The peripheral edge portion of the opposing base fabrics 31 and 32 is closed by the peripheral edge joint portion 33, and the second chamber 30 is formed.

Furthermore, in first to fifth connection portions R1 to R5, the base fabrics 21, 22, 31 and 32 are joined, and the first chamber 20 and the second chamber 30 are connected. The first connection portion R1 connects the first chamber 20 and the second chamber 30 in a rearward portion of the airbag 10A. The second connection portion R2 and the third connection portion R3 (refer to FIG. 3C) connect the one base fabric 21 of the first chamber 20 and the one base fabric 31 of the second chamber 30 in the surround of the inflator 3. The fourth connection portion R4 (refer to FIGS. 3A and 3B) connects the one base fabric 21 of the first chamber 20 and the one base fabric 31 of the second chamber 30 on the boundary of the internal inflation portion 23 and the external inflation portion 24. A portion between the overlapped base fabrics 21 and 31 is closed by the fourth connection portion R4. The fifth connection portion R5 connects the other base fabric 22 of the first chamber 20 and the other base fabric 32 of the second chamber 30 on the boundary of the internal inflation portion 23 and the external inflation portion 24. A portion between the overlapped base fabrics 22 and 32 is closed by the fifth connection portion R5. According to the connection described above, the first chamber 20 and the second chamber 30 are formed into the airbag 10A.

The second chamber 30 is an occupant protection portion which comes into contact with the occupant 90 so as to protect the occupant 90, and surrounds a part (the internal inflation portion 23) of the first chamber 20 including the distribution port 14. Furthermore, at least a part of the second chamber 30 surrounds the internal inflation portion 23 in such a manner that the internal inflation portion 23 is arranged in a rearward portion (a portion close to the seat 80) of the second chamber 30. The gas supplied from the inflator 3 is supplied to the second chamber 30 via the distribution port 14. The second chamber 30 inflates and deploys in retard of the first chamber 20 by the gas, and the gas is filled in the second chamber 30. By inflation and deployment of the first chamber 20 and the second chamber 30 while shifting timing, a whole of the airbag 10A inflates and deploys.

When the airbag 10A receives the occupant 90, the gas within the second chamber 30 is discharged out of the vent hole 11. The vent hole 11 is formed in the second chamber 30 by not partly joining the base fabrics 31 and 32 of the second chamber 30. The second chamber 30 is connected to an external portion of the airbag 10A through the vent hole 11. The first chamber 20 does not have the vent hole 11, and the vent hole 11 is formed only in the second chamber 30. Therefore, the airbag 10A discharges the gas to the external portion only from the vent hole 11 of the second chamber 30.

An area of the vent hole 11 is smaller than an area of the distribution port 14. As a result, an amount of the gas discharged from the vent hole 11 is smaller than an amount of the gas supplied to the second chamber 30 from the distribution port 14. These two areas are set in correspondence to a condition (for example, an inflation speed of the second chamber 30 or absorbing characteristics of impact shock by the airbag 10A) required for the airbag 10A. In addition, the discharge amount of gas and the supply amount of gas are adjusted by changing two areas.

Meanwhile, the area of the vent hole 11 is the area of the vent hole 11 during discharge of the gas. In the case where the second chamber 30 has a plurality of vent holes 11, the area of the vent hole 11 is the area obtained by summing up the areas of the plurality of vent holes 11. Furthermore, the area of the distribution port 14 is the area of the distribution port 14 during supply of the gas. In the case where the first chamber 20 has a plurality of distribution ports 14, the area of the distribution port 14 is the area obtained by summing up the areas of the plurality of distribution ports 14.

Next, a description will be given in detail of the inflation and deployment of the airbag 10A.

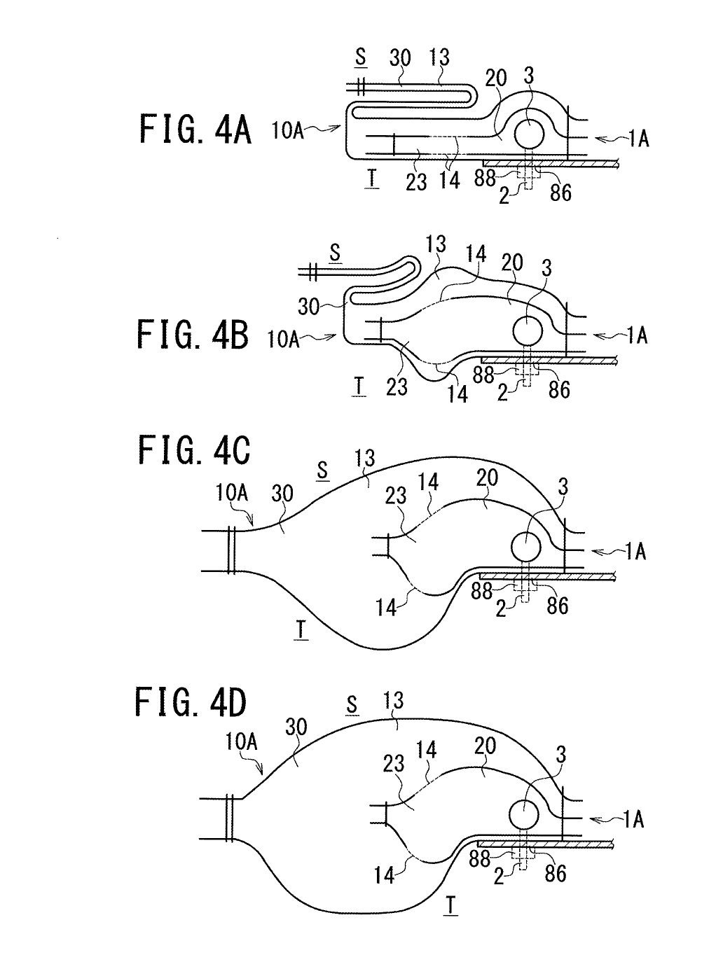

FIGS. 4A to 4D are views showing a deployment process of the airbag 10A, and schematically show the airbag 10A by a cross-sectional views corresponding to FIG. 3C. In FIGS. 4A to 4D, an upper side is a vehicle outside S (the side wall 89 side), and a lower side is a vehicle interior side T (the vehicle cabin side).

The airbag device 1A is attached to the attaching portion 86 (the seat frame) of the vehicle by the attaching members 2 (the bolts) and the fixing members 88 (the nuts), as illustrated. Furthermore, the inflator 3 and the airbag 10A are arranged on the vehicle outside S (an outer side in a width direction) of the attaching portion 86 within the seat 80 (not shown in FIGS. 4A to 4D).

By the gas generated by the inflator 3, the first chamber 20 and the second chamber 30 jump out of the seat 80 to thereby deploy in the lateral space 87. Since the gas is first supplied to the first chamber 20 storing the inflator 3 at this time, the deployment of the first chamber 20 is first started, and the folded first chamber 20 deploys so as to expand (refer to FIG. 4A). Subsequently, the first chamber 20 gradually inflates, and the internal inflation portion 23 of the first chamber 20 inflates within the folded second chamber 30 (refer to FIG. 4B). As described above, the first chamber 20 deploys at an early stage at a predetermined position within the vehicle (the lateral space 87; refer to FIG. 2) and into a predetermined shape. Furthermore, the internal inflation portion 23 of the first chamber 20 inflates and deploys along the body 92 (refer to FIG. 2) within the rearward portion of the second chamber 30, and the external inflation portion 24 of the first chamber 20 inflates and deploys more greatly in the lateral portion of the head 91 than in the head 91 (refer to FIG. 2) (refer to FIG. 2).

Due to the inflation and deployment of the internal inflation portion 23, the folded second chamber 30 deploys so as to partly expand (refer to FIG. 4B). Furthermore, before the first chamber 20 completely inflates and deploys, the gas within the first chamber 20 flows out from the distribution port 14 formed in the internal inflation portion 23 to the second chamber 30. By the gas supplied from the distribution port 14, a whole of the second chamber 30 deploys, and the second chamber inflates and deploys in the surround of the internal inflation portion 23 after the inflation and deployment of the first chamber 20 (refer to FIG. 4C). Next, the inflation of the first chamber 20 and the second chamber 30 makes progress, and the first chamber 20 completely inflates and deploys. A portion on a forward side of the first chamber 20 expands to a vehicle interior side T (an inner side in the width direction) with respect to the attaching portion 86, in the outer side of the seat 80. In the same manner, a portion on a forward side of the second chamber 30 expands to the vehicle interior side T with respect to the attaching portion 86, on the outer side of the seat 80.

After the completion of the inflation of the first chamber 20, the inflation of the second chamber 30 is completed (refer to FIG. 4D), and a whole of the inflated internal inflation portion 23 is stored within the second chamber 30. The second chamber 30 inflates around the inflated internal inflation portion 23 more greatly and more thickly than the internal inflation portion 23. Furthermore, the second chamber 30 (refer to FIG. 2) inflates and deploys to the lateral portion of the body 92 so as to overlap a whole of the body 92. Each of portions of the occupant 90 is received and protected by the chamber s 20 and 30 which has inflated and deployed in the lateral space 87.

Here, since the head 91 of the occupant 90 is a portion required to be protected early, it is necessary to inflate and deploy, at an early stage, the external inflation portion 24 (the head protection portion 12; refer to FIG. 2) of the first chamber 20. In contrast to this, in the airbag 10A, the first chamber 20 inflates and deploys in advance so as to protect the head 91 at an early stage, and the external inflation portion 24 is put into a state of being able to protect the head 91 at an early stage. At the same time, the internal inflation portion 23 inflates and deploys at an early stage, and is put into a state of being able to partly protect the body 92.

Since the gas within the first chamber 20 flows out from only the distribution port 14 to the external portion (the second chamber 30), the gas outflow from the first chamber 20 is suppressed. Therefore, the first chamber 20 quickly inflates and deploys, and the internal pressure of the first chamber 20 is maintained at a high pressure. In conjunction with this, the first chamber 20 becomes stable, and the position of the first chamber 20 is maintained at a predetermined position. In addition, the external inflation portion 24 (refer to FIG. 2) is supported by the internal inflation portion 23 which retains a high internal pressure, and is stably arranged in the lateral portion of the head 91. Even after the gas supply by the inflator 3 stops, the first chamber 20 is maintained long time in an inflated state, and thus the position of the external inflation portion 24 is maintained at a position where the head 91 can be protected. In addition, since the internal inflation portion 23 is attached to the attaching portion 86 by the inflator 3, the first chamber 20 is more stable.

As described above, the external inflation portion 24 of the first chamber 20 inflates and deploys at an early stage and is maintained long time in a state of being able to protect the head 91 of the occupant 90. As a result, even if the timing when the head 91 comes into contact with the external inflation portion 24 fluctuates, the head 91 is reliably received and protected by the external inflation portion 24 which inflates and deploys, whereas the body 92 of the occupant 90 is received and protected by the second chamber 30 and the internal inflation portion 23 of the first chamber 20.

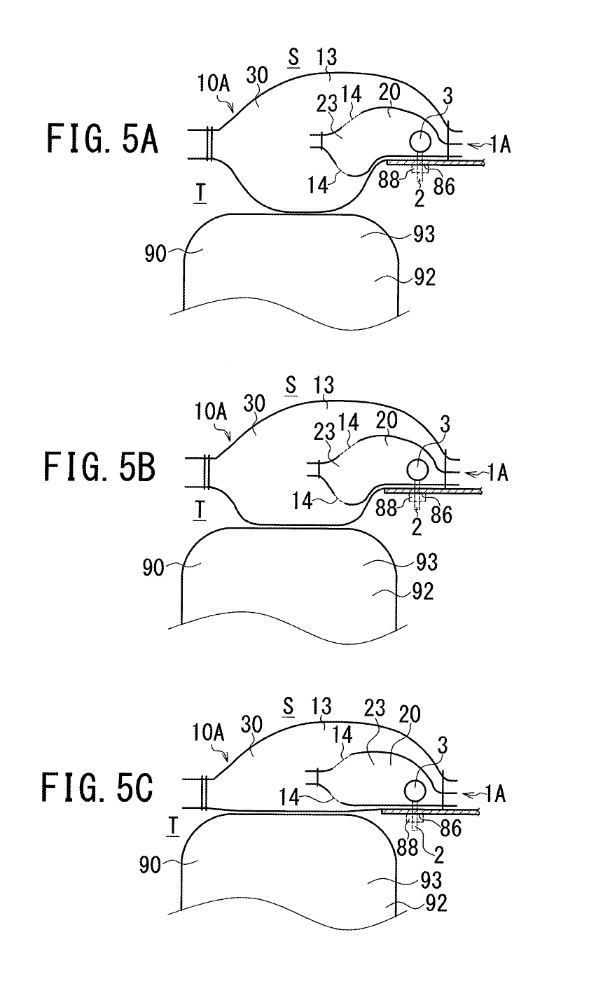

FIGS. 5A to 5C are views showing the airbag 10A which protects the body 92 of the occupant 90, and show the airbag 10A in correspondence to FIGS. 4A to 4D.

The second chamber 30 is the body protection portion 13 formed in the lower portion of the airbag 10A, as shown, and protects the body 92 by inflation in the lateral portion of the body 92. When the body 92 comes into contact with the inflated and deployed second chamber 30 (refer to FIGS. 5A and 5B), the second chamber 30 deforms so as to be crushed, and the impact shock in the body 92 is absorbed by the deforming second chamber 30. At this time, since the gas within the second chamber 30 is discharged out of the vent hole 11 (not shown in FIGS. 5A to 5C), the body 92 is softly received by the second chamber 30 and the impact shock is absorbed.

Subsequently, a part (here, the chest 93) of the body 92 comes into contact with the inflated internal inflation portion 23 of the first chamber 20 (refer to FIG. 5C). As a result, the movement of the body 92 is suppressed, and the impact shock in the body 92 is absorbed by the internal inflation portion 23 which retains the high internal pressure. Therefore, the body protection portion 13 of the airbag 10A is constituted of the second chamber 30 and the internal inflation portion 23. The body 92 is protected by the second chamber 30, and a part of the body 92 is protected by the second chamber 30 and the internal inflation portion 23. In the portion where the second chamber 30 and the internal inflation portion 23 overlap with each other, the impact shock is gradually absorbed by the second chamber 30 and the internal inflation portion 23, and the body 92 is gradually protected.

Whereas, when the occupant 90 moves close to the side wall 89, the body 92 of the occupant 90 may come into contact with the second chamber 30 during the inflation and deployment. At this time, since the internal inflation portion 23 rapidly inflates and deploys, a part of the body 92 is received by the internal inflation portion 23 which retains the high internal pressure, after the body 92 comes into contact with the second chamber 30. As a result, the movement of the body 92 is suppressed, and the impact shock in the body 92 is absorbed. In addition, the body 92 is prevented from colliding with the side wall 89, and the body 92 is protected.

As described above, in the airbag device 1A according to the first embodiment, it is possible to inflate and deploy the first chamber 20 required to be inflated and deployed at an early stage in advance so as to be able to protect the occupant 90 at an early stage. Furthermore, even in the case where the occupant 90 comes into contact with the second chamber 30 during the inflation and deployment, it is possible to absorb the impact shock and protect the occupant 90.

The first chamber 20 and the second chamber 30 are connected only by the distribution port 14, and the second chamber 30 inflates and deploys only by the gas which is supplied from the distribution port 14. As a result, it is possible to easily change each of the internal pressures of the chamber s 20 and 30 and the inflation and deployment timings (inflation and deployment speeds) of the chamber s 20 and 30, by adjusting the distribution port 14. Therefore, it is possible to set each of the internal pressures of the chamber s 20 and 30 in correspondence to the portion to be protected in the occupant 90. Furthermore, it is also possible to set each of the inflation and deployment timings of the chamber s 20 and 30 in correspondence to the contact timing of each of the portions of the occupant 90. It is possible to reliably absorb the impact shock of the occupant 90 by adjusting ways of inflation and deployment of the first chamber 20 and the second chamber 30 as described above, and thus it is possible to appropriately protect the occupant 90.

Since the airbag 10A discharges the gas only from the vent hole 11 of the second chamber 30, the gas outflow from the first chamber 20 is suppressed. As a result, it is possible to inflate and deploy the first chamber 20 at an early stage, and to maintain the first chamber 20 for a long time and stably in a state where the occupant 90 can be protected. Furthermore, it is also possible to maintain the high internal pressure of the first chamber 20. When an area of the vent hole 11 is made smaller than an area of the distribution port 14, an amount of gas supplied to the second chamber 30 becomes more than an amount of gas discharged from the second chamber 30, and the second chamber 30 reliably inflates and deploys. As a result, it is desirable to make the area of the vent hole 11 smaller than the area of the distribution port 14.

Since the internal inflation portion 23 and the second chamber 30 are attached to the attaching portion 86 of the vehicle by the inflator 3 within the internal inflation portion 23, the airbag device 1A can be easily attached to the vehicle. Since the internal inflation portion 23 is constituted of the tubular portion which stores the inflator 3, it is possible to move the external inflation portion 24 to a predetermined position within the vehicle at an early stage, by the deployment of the internal inflation portion 23. Furthermore, the external inflation portion 24 can be firmly supported by the tubular internal inflation portion 23 which inflates and deploys, and it is also possible to enhance stability of the first chamber 20.

Meanwhile, the first chamber 20 and the second chamber 30 can be formed into various shapes in correspondence to the deployment position within the vehicle and the portion of the occupant 90 to be protected. Furthermore, the internal inflation portion 23 of the first chamber 20 can be formed into the shapes other than the tubular shape in correspondence to the shape of the seat 80, and the greatly inflating portion may be formed in the internal inflation portion 23 in such a manner as to be able to protect the waist 94. The vent hole 11 and the distribution port 14 can be formed into a shape and at a position which are different from the above. The first chamber 20 and the second chamber 30 may be formed by the different kinds of base fabrics. For example, in the case where the first chamber 20 is formed by the base fabrics 21 and 22 which have high airtightness, the internal pressure of the first chamber 20 is maintained, and stability of the first chamber 20 becomes high. On the other hand, in the second chamber 30 having the vent hole 11, the airtightness may be lower than in the first chamber 20. As a result, the second chamber 30 may be formed by the base fabrics 31 and 32 (the non-coated base fabrics or the like) having the lower airtightness than the base fabrics 21 and 22 of the first chamber 20. As a result, it is possible to reduce a cost of the airbag 10A.

Next, a description will be given of airbag devices according to the other embodiments which are partly different from the airbag device 1A according to the first embodiment. The airbag devices (the airbags) according to second to eighth embodiments described below have basically the same configuration as the airbag device 1A (the airbag 10A) according to the first embodiment. Furthermore, in the airbag devices according to the second to eighth embodiments, the same effects as those of the airbag device 1A according to the first embodiment can be obtained. Therefore, hereinafter, a description will be given below of matters which are different from the already described matters, and a description of the same matters as the already described matters will be omitted. As to the airbag devices and the airbags according to the second to eighth embodiments, the same terms and reference numerals are attached to the same configurations as those of the airbag device 1A and the airbag 10A according to the first embodiment.

### Second Embodiment

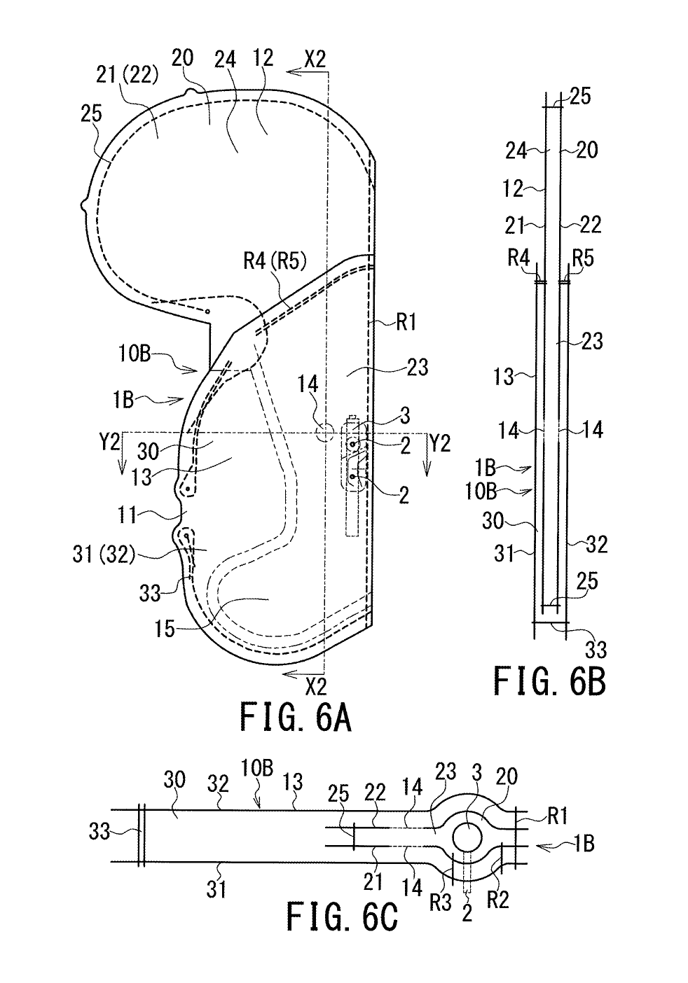

FIGS. 6A to 6C are views showing an airbag device 1B according to the second embodiment. FIG. 6A is a side view of an airbag 10B according to the second embodiment, FIG. 6B is a cross-sectional view of the airbag 10B cut along a line X2-X2 in FIG. 6A, and FIG. 6C is a cross-sectional view of the airbag 10B cut along a line Y2-Y2 in FIG. 6A.

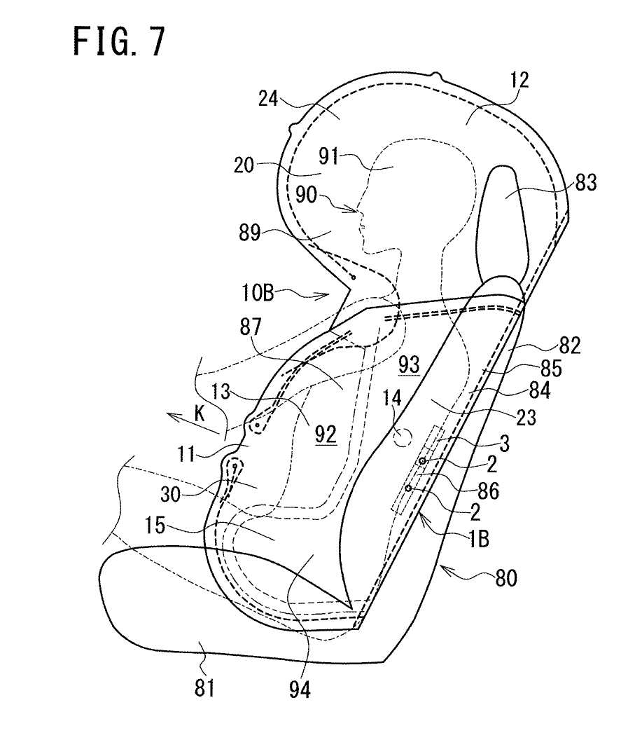

FIG. 7 is a side view showing the inflated and deployed airbag 10B, and shows the airbag 10B in correspondence to FIG. 2.

In the airbag device 1B, an internal inflation portion 23 of a first chamber 20 is different from the airbag 10A (refer to FIGS. 3A to 3C) according to the first embodiment. The first chamber 20 has a waist protection portion 15 which is formed in a downward portion of the internal inflation portion 23. The waist protection portion 15 is a protruding inflation portion of the internal inflation portion 23 which inflates in the lateral portion of the waist 94, and inflates so as to protrude forward within a second chamber 30.

In the case where the gas is supplied from an inflator 3, the waist protection portion 15 inflates and deploys along the waist 94 within the second chamber 30. In the case where the waist 94 comes into contact with the inflated and deployed second chamber 30, the second chamber 30 deforms, and the waist 94 is received by the inflated waist protection portion 15. As a result, the movement of the waist 94 is suppressed. Furthermore, the impact shock in the waist 94 is absorbed by the second chamber 30 and the waist protection portion 15, and the waist 94 is protected. In the case where the waist 94 comes into contact with the second chamber 30 during the inflation and deployment, the waist 94 is received and protected by the waist protection portion 15 which retains the high internal pressure, after coming into contact with the second chamber 30.

### Third Embodiment

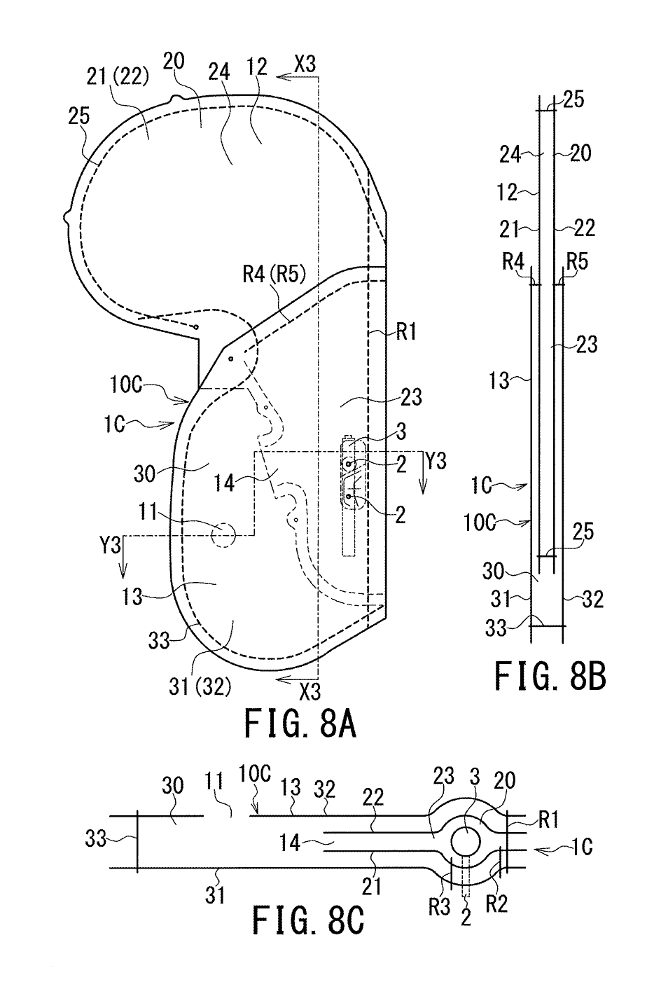

FIGS. 8A to 8C are views showing an airbag device 1C according to the third embodiment. FIG. 8A is a side view of an airbag 10C according to the third embodiment, FIG. 8B is a cross-sectional view of the airbag 10C cut along a line X3-X3 in FIG. 8A, and FIG. 8C is a cross-sectional view of the airbag 10C cut along a line Y3-Y3 in FIG. 8A.

In the airbag device 1C, a vent hole 11 and a distribution port 14 of the airbag 10C are different from the airbag 10A (refer to FIGS. 3A to 3C) according to the first embodiment, as illustrated. The vent hole 11 is constituted of a circular through-hole which is formed in a base fabric 32 of a second chamber 30, and is provided in one side surface of the second chamber 30. The gas within the second chamber 30 is discharged to a lateral portion of the airbag 10C from one vent hole 11. The distribution port 14 is formed in a first chamber 20 (an internal inflation portion 23) within the second chamber 30 by not partly joining base fabrics 21 and 22 of the first chamber 20. The gas within the first chamber 20 flows out forward from one distribution port 14 and is supplied to the second chamber 30.

### Fourth Embodiment

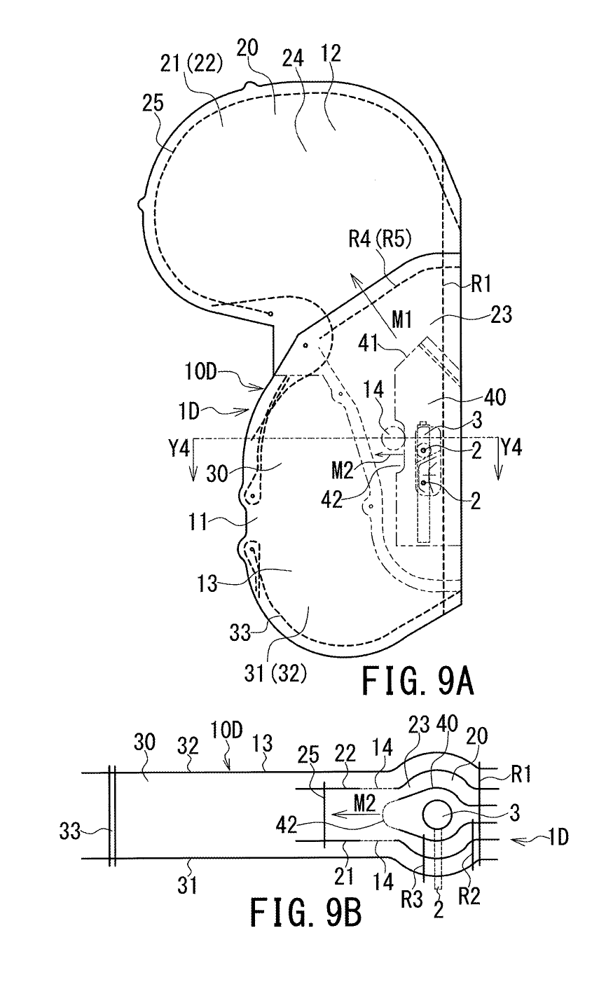

FIGS. 9A and 9B are views showing an airbag device 1D according to the fourth embodiment. FIG. 9A is a side view of an airbag 10D according to the fourth embodiment, and FIG. 9B is a cross-sectional view of the airbag 10D cut along a line Y4-Y4 in FIG. 9A.

The airbag device 1D is provided with the airbag 10D which is the same as the airbag 10A (refer to FIGS. 3A to 3C) according to the first embodiment, as shown. Furthermore, the airbag 10D has a tubular diffuser 40 stored within a first chamber 20.

The diffuser 40 is formed by, for example, joining overlapped base fabrics, and is arranged along a vertical direction within an internal inflation portion 23. An inflator 3 is attached to the attaching portion 86 of the vehicle in a state of being stored within the diffuser 40. The diffuser 40 is connected to the airbag 10D in a first connection portion R1, and is attached to the attaching portion 86 by the inflator 3.

The diffuser 40 is for adjustment of gas flow, and has two gas outflow ports 41 and 42. The first outflow port 41 is formed in an upward end portion of the diffuser 40, and the second outflow port 42 is formed in a forward edge portion of the diffuser 40. When the inflator 3 generates gas within the diffuser 40, the gas flows out of the diffuser 40 through the outflow ports 41 and 42, and is supplied to the first chamber 20. At this time, the gas is supplied toward an external inflation portion 24 from the first outflow port 41 (an arrow M1), and the external inflation portion 24 inflates and deploys. Furthermore, the gas is supplied toward the internal inflation portion 23 from the second outflow port 42 (an arrow M2), and is supplied to the second chamber 30 through the distribution port 14. The internal inflation portion 23 and the second chamber 30 inflate and deploy in sequence by the gas.

As described above, through the use of the diffuser 40, it is possible to smoothly supply the gas toward a predetermined portion within the airbag 10D by adjusting the gas flow. As a result, it is possible to more rapidly inflate and deploy the first chamber 20 required to be deployed at an early stage in the airbag 10D. Furthermore, it is possible to adjust the way of inflation and deployment of each of the portions in the airbag 10D.

Meanwhile, the first outflow port 41 may be close to the external inflation portion 24, and the first outflow port 41 may be arranged within the external inflation portion 24. The diffuser 40 may be provided with one outflow port or three or more outflow ports. Moreover, a downward end portion of the diffuser 40 may be closed by joining or the like. The downward end portion of the diffuser 40 may be opened to thereby be used as a third outflow port. In this case, the gas is supplied toward a downward side of the internal inflation portion 23 from the third outflow port.

### Fifth Embodiment

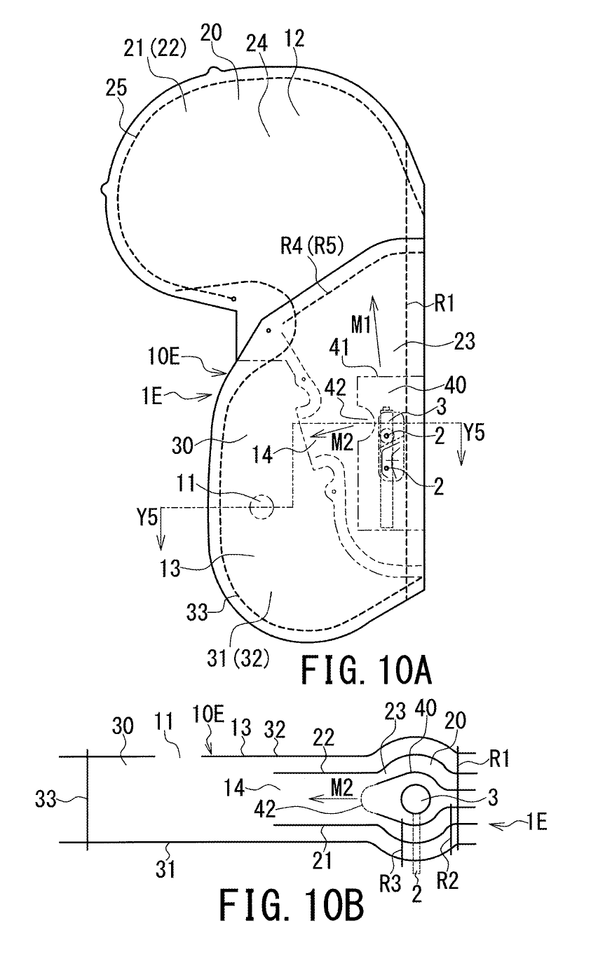

FIGS. 10A and 10B are views showing an airbag device 1E according to the fifth embodiment. FIG. 10A is a side view of an airbag 10E according to the fifth embodiment, and FIG. 10B is a cross-sectional view of the airbag 10E cut along a line Y5-Y5 in FIG. 10A.

The airbag device 1E is provided with the airbag 10E which is the same as the airbag 10C (refer to FIGS. 8A to 8C) according to the third embodiment, as shown. Furthermore, the airbag 10E has a diffuser 40 in the same manner as the airbag 10D (refer to FIGS. 9A and 9B) according to the fourth embodiment. The diffuser 40 adjusts the gas flow by flowing out the gas from two outflow ports 41 and 42. At this time, the gas flows out toward a distribution port 14 from the second outflow port 42, and is supplied to the second chamber 30 through the distribution port 14.

### Sixth Embodiment

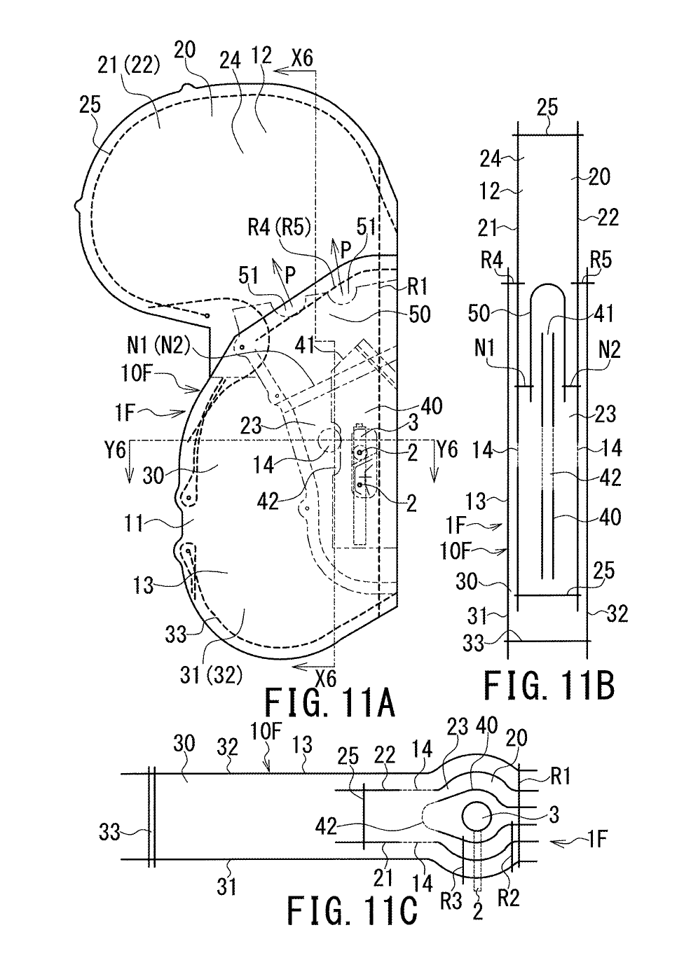

FIGS. 11A to 11C are views showing an airbag device 1F according to the sixth embodiment. FIG. 11A is a side view of an airbag 10F according to the sixth embodiment, FIG. 11B is a cross-sectional view of the airbag 10F cut along a line X6-X6 in FIG. 11A, and FIG. 11C is a cross-sectional view of the airbag 10F cut along a line Y6-Y6 in FIG. 11A.

The airbag device 1F is provided with the airbag 10F having a diffuser 40 in the same manner as the airbag 10D (refer to FIGS. 9A and 9B) according to the fourth embodiment, as shown. In addition, the airbag 10F has a check valve 50 which is provided within a first chamber 20. The check valve 50 is a valve for one way gas flow, and is arranged between an internal inflation portion 23 and an external inflation portion 24 within the first chamber 20. The check valve 50 is constituted of a two-folded base fabric, and is arranged between base fabrics 21 and 22 of the first chamber 20 in a state where a folding line is directed to the external inflation portion 24 side. Furthermore, the opposing portions of the base fabric of the check valve 50 are respectively joined to the base fabrics 21 and 22 by joint portions N1, N2 and the like, and divide an inner portion of the first chamber 20 into the internal inflation portion 23 and the external inflation portion 24.

When an inflator 3 generates the gas within the internal inflation portion 23, the gas flows along an inner side of the check valve 50 and passes through two gas passing ports 51 formed in a leading end portion of the check valve 50 (an arrow P in FIG. 11A). The passing ports 51 are positioned within the external inflation portion 24, and the gas is supplied to the external inflation portion 24 only from the passing port 51. The external inflation portion 24 divided by the check valve 50 inflates and deploys by the gas. At this time, since the opposing portions of the base fabric of the check valve 50 are distanced by the gas flowing within the check valve 50, the check valve 50 (the passing ports 51) is maintained in an open state.

In contrast to this, when the external inflation portion completely inflates, internal pressure difference is generated between internal pressures of two inflation portions 23 and 24, and the internal pressure of the external inflation portion 24 becomes higher than the internal pressure of the internal inflation portion 23. Due to the difference of the internal pressure, the opposing portions of the base fabric of the check valve 50 closely contact, and the check valve 50 (the passing ports 51) is closed. After that, even when the head 91 of the occupant 90 is received by the inflated external inflation portion 24, the check valve 50 is maintained in a closed state. In the same manner, when the head 91 is received by the external inflation portion 24 during the inflation, the opposing portions of the base fabric of the check valve 50 closely contact due to the increase of the internal pressure of the external inflation portion 24, and the check valve 50 is closed.

As described above, the check valve 50 allows the gas flow from the internal inflation portion 23 to the external inflation portion 24, and restricts the gas flow from the external inflation portion 24 to the internal inflation portion 23. Since the outflow of the gas from the external inflation portion 24 can be suppressed by the check valve 50, the external inflation portion 24 can be maintained in an inflated state. Furthermore, since the high internal pressure of the external inflation portion 24 can be maintained, the head 91 can be reliably protected.

### Seventh Embodiment

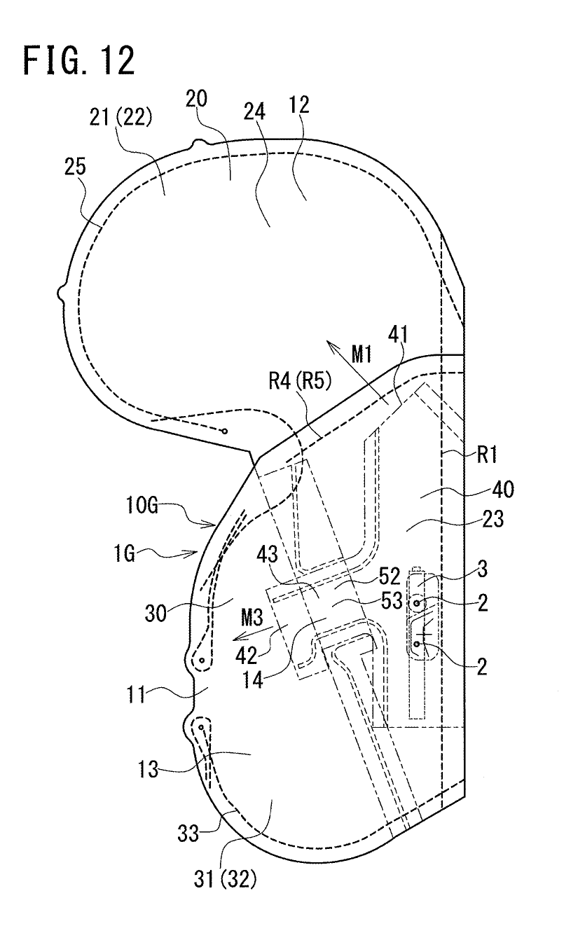

FIG. 12 is a view showing an airbag device 1G according to a seventh embodiment, and shows a side view of an airbag 10G according to the seventh embodiment.

In the airbag device 1G, a distribution port 14 of the airbag 10G is different from the airbag 10A (refer to FIGS. 3A to 3C) according to the first embodiment, as shown. Furthermore, the airbag 10G has a diffuser 40, and a closing valve 52 which closes the distribution port 14 of a first chamber 20.

The distribution port 14 is formed in the first chamber 20 (an internal inflation portion 23) within a second chamber 30 by not partly joining base fabrics 21 and 22 of the first chamber 20. The diffuser 40 has a tubular gas passage 43, and a second outflow port 42 formed in a leading end portion of the gas passage 43. The gas passage 43 protrudes forward from the diffuser 40, and is arranged from the internal inflation portion 23 to the second chamber 30 through the distribution port 14. The leading end portion of the gas passage 43 and the second outflow port 42 are arranged within the second chamber 30.

The closing valve 52 is constituted of two opposing base fabrics and is arranged between the base fabrics 21 and 22 of the first chamber 20 so as to cover the distribution port 14 and the gas passage 43. The opposing base fabrics of the closing valve 52 are joined to the base fabrics 21 and 22 by a peripheral edge joint portion 25, and are joined so as to be along an edge portion of the gas passage 43. As a result, the closing valve 52 is connected to the internal inflation portion 23, and is arranged around the distribution port 14 of the internal inflation portion 23. Furthermore, a penetration portion 53 is formed between the opposing base fabrics of the closing valve 52, and the internal inflation portion 23 and the second chamber are connected via the penetration portion 53. The distribution port 14 is constituted of the penetration portion 53 of the closing valve 52, and the gas passage 43 is arranged between the opposing base fabrics of the closing valve 52 within the penetration portion 53.

In the case where the inflator 3 generates the gas within the diffuser 40, the gas flows out forward from the second outflow port 42 through the gas passage 43 and the distribution port 14, and is directly supplied to the second chamber 30 (an arrow M3). The second chamber 30 inflates and deploys by the gas. At this time, since the opposing base fabrics of the closing valve 52 (the penetration portion 53) are distanced by the gas flowing within the gas passage 43, the closing valve 52 and the distribution port 14 are maintained in an open state. When the first chamber 20 completely inflates, the difference between internal pressures of two chamber s 20 and 30 is generated, and the internal pressure of the first chamber 20 becomes higher than the internal pressure of the second chamber 30. Because of the difference of the internal pressure, the opposing base fabrics of the closing valve 52 closely contact, and the closing valve 52 is closed. Consequently, the closing valve 52 closes the distribution port 14 together with the gas passage 43. After that, also when the occupant 90 is received by the inflated first chamber 20, the closing valve 52 and the distribution port 14 are maintained in a closed state.

As described above, the closing valve 52 is a closing member which closes the distribution port 14 of the first chamber 20, and closes the distribution port 14 in a state where a whole or a part (here, the first chamber 20) of the airbag 10G inflates and deploys. Since it is possible to suppress the outflow of the gas from the first chamber 20 to the second chamber 30 by the closing valve 52, the first chamber 20 can be maintained in an inflated state. Furthermore, since the high internal pressure of the first chamber 20 can be maintained, it is possible to reliably protect the head 91 and the body 92. The external inflation portion 24 can be maintained at a predetermined position by the support of the inflated internal inflation portion 23. Meanwhile, the check valve 50 may be provided in the first chamber 20 of the airbag 10G.

### Eighth Embodiment

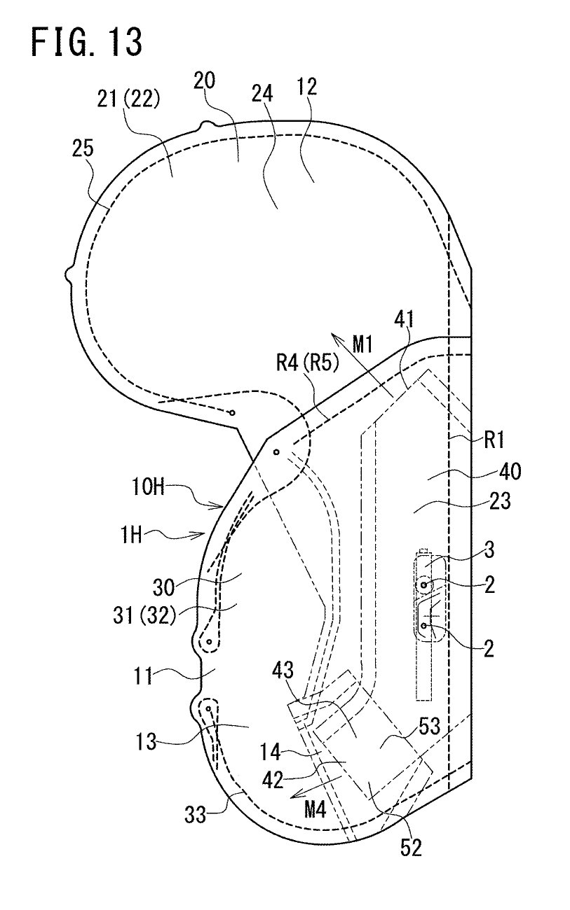

FIG. 13 is a view showing an airbag device 1H according to the eighth embodiment, and shows a side view of an airbag 10H according to the eighth embodiment.

In the airbag device 1H, a distribution port 14, a gas passage 43 and a closing valve 52 are different from the airbag 10G (refer to FIG. 12) according to the seventh embodiment, as shown.

The distribution port 14 is formed in a downward end portion of an internal inflation portion 23. The gas passage 43 is formed in a downward end portion of a diffuser 40, and protrudes diagonally downward from the diffuser 40. A leading end portion of the gas passage 43 and a second outflow port 42 are arranged in the vicinity of the distribution port 14 within the internal inflation portion 23. The closing valve 52 is arranged within the internal inflation portion 23, and is connected to the distribution port 14 so as to cover the distribution port 14. Furthermore, the closing valve 52 is arranged so as to be directed from the distribution port 14 to the diffuser 40, and the gas passage 43 and the distribution port 14 are arranged within a penetration portion 53 of the closing valve 52.

The gas flows out forward through the gas passage 43, the second outflow port 42 and the distribution port 14, and is directly supplied to the second chamber 30 (an arrow M4). At this time, the closing valve 52 (the penetration portion 53) and the distribution port 14 are maintained in an open state, by the gas flowing within the gas passage 43. In the case where the first chamber 20 completely inflates, the closing valve 52 is closed due to the difference of internal pressures of two chambers 20 and 30, and the distribution port 14 is closed together with the gas passage 43, by the closing valve 52. Even in the case where the occupant 90 is thereafter received by the inflated first chamber 20, the closing valve 52 and the distribution port 14 are maintained in a closed state.

The description has been given above of the examples in which the present invention is applied to the side airbag device, but the present invention can also be applied to airbag devices (for example, an airbag device for a driver seat, and an airbag device for a front passenger seat) other than the side airbag device. In this case, the same first chamber and second chamber as described above are formed in the airbag of each of the airbag devices. Furthermore, each of the airbag devices is attached to an attaching portion (for example, a steering wheel and an instrument panel) of the vehicle.

### REFERENCE SIGNS LIST

1A-1H: airbag device
2: attaching member
3: inflator
10A-10H: airbag
11: vent hole
12: head protection portion
13: body protection portion
14: distribution port (gas distribution port)
15: waist protection portion
20: first chamber
21, 22: base fabric
23: internal inflation portion (a part of first chamber)
24: external inflation portion
25: peripheral edge joint portion
30: second chamber
31, 32: base fabric
33: peripheral edge joint portion
40: diffuser
41, 42: outflow port
43: gas passage
50: check valve
51: passing port
52: closing valve
53: penetration portion
80: seat
81: seat cushion
82: seat back
83: head rest
84: storage member
85: side portion
86: attaching portion
87: lateral space
88: fixing member
89: side wall
90: occupant
91: head
92: body
93: chest
94: waist

1. An airbag device comprising:
an airbag which protects an occupant in a vehicle upon inflation and deployment thereof by gas; and
an inflator which supplies the gas to the airbag,
wherein the airbag has a first chamber which stores the inflator, the first chamber being inflatable by the gas supplied from the inflator, a gas distribution port provided in the first chamber, and a second chamber which surrounds a part of the first chamber including the distribution port, the second chamber being inflatable by the gas supplied from the distribution port.

2. The airbag device according to claim 1, wherein a part of the first chamber is comprised of an internal inflation portion which inflates inside the second chamber, and an external inflation portion which inflates outside the second chamber, and
wherein the distribution port is provided in the internal inflation portion of the first chamber.

3. The airbag device according to claim 2, wherein the inflator is stored within the internal inflation portion of the first chamber, and is attached to an attaching portion of the vehicle together with the internal inflation portion and the second chamber which overlaps the internal inflation portion.

4. The airbag device according to claim 2, wherein the internal inflation portion of the first chamber is constituted of a tubular portion which stores the inflator.

5. The airbag device according to claim 2, further comprising a check valve which is arranged between the internal inflation portion and the external inflation portion within the first chamber, which allows gas flow from the internal inflation portion to the external inflation portion, and which restricts gas flow from the external inflation portion to the internal inflation portion.

6. The airbag device according to claim 2, further comprising a closing valve which closes the distribution port of the first chamber in a state where the airbag inflates and deploys.

7. The airbag device according to claim 1, wherein the airbag has a vent hole provided in the second chamber, and the gas is discharged only from the vent hole of the second chamber.

8. The airbag device according to claim 7, wherein an area of the vent hole is smaller than an area of the distribution port.

9. The airbag device according to claim 3, wherein the internal inflation portion of the first chamber is constituted of a tubular portion which stores the inflator.

10. The airbag device according to claim 3, further comprising a check valve which is arranged between the internal inflation portion and the external inflation portion within the first chamber, which allows gas flow from the internal inflation portion to the external inflation portion, and which restricts gas flow from the external inflation portion to the internal inflation portion.

11. The airbag device according to claim 4, further comprising a check valve which is arranged between the internal inflation portion and the external inflation portion within the first chamber, which allows gas flow from the internal inflation portion to the external inflation portion, and which restricts gas flow from the external inflation portion to the internal inflation portion.

12. The airbag device according to claim 3, further comprising a closing valve which closes the distribution port of the first chamber in a state where the airbag inflates and deploys.

13. The airbag device according to claim 4, further comprising a closing valve which closes the distribution port of the first chamber in a state where the airbag inflates and deploys.

14. The airbag device according to claim 5, further comprising a closing valve which closes the distribution port of the first chamber in a state where the airbag inflates and deploys.

15. The airbag device according to claim 2, wherein the airbag has a vent hole provided in the second chamber, and the gas is discharged only from the vent hole of the second chamber.

16. The airbag device according to claim 3, wherein the airbag has a vent hole provided in the second chamber, and the gas is discharged only from the vent hole of the second chamber.

17. The airbag device according to claim 4, wherein the airbag has a vent hole provided in the second chamber, and the gas is discharged only from the vent hole of the second chamber.

18. The airbag device according to claim 5, wherein the airbag has a vent hole provided in the second chamber, and the gas is discharged only from the vent hole of the second chamber.

19. The airbag device according to claim 6, wherein the airbag has a vent hole provided in the second chamber, and the gas is discharged only from the vent hole of the second chamber.
